(19) United States
(12) Patent Application Publication
(10) Pub. No.: US 2005/0102233 A1
(43) Pub. Date: May 12, 2005

(54) Associating mobile phone to vending machine via bar-code encoded data, CCD camera and internet connection

(75) Inventors: Kenneth James Park, Portland, OR (US); Atsushi Ishii, Vancouver, WA (US)

Correspondence Address: ROBERT D. VARITZ, P.C., 2007 S.E. GRANT STREET, PORTLAND, OR, 97214, US

(73) Assignee: Sharp Laboratories of America, Inc.

(21) Appl. No.: 10/703,047

(22) Filed: Nov. 6, 2003

(51) Int. Cl. G06F 17/60

(52) U.S. Cl. 705/44

(57) ABSTRACT

A method of making purchases with a mobile communications device account from a vending machine includes providing a mobile communication device with an image capture mechanism; providing a vending machine with a data display; capturing the data display of the vending machine with the image capturing mechanism; decoding the data display in the mobile communication device to determine a URL for a vendor server and an identification number for the vending machine; transmitting the identification number to the vendor server; authorizing the dispensing of product from the vending machine by the vendor server; and billing the mobile communication device user account on a mobile communication device accounting server.

### FIELD OF THE INVENTION

This invention relates to a vending machine-mobile communication device interface, and specifically to an optical implementation of such an interface.

### BACKGROUND OF THE INVENTION

WO9838761, to Durst et al., published Sep. 3, 1998, describes a method for encoding a host Internet Protocol (IP) address within a linear i.e., one dimensional, barcode which enables a direct link to a designated host computer without third party intervention, however, the reference does not disclose that the bar code could be read from an LCD, nor does the reference disclose that the bar code could contain a unique value that identifies exactly where the barcode is displayed, further the reference does not disclose that the state of the bar code is under control of a remote server and is dynamic.

WO0197105, to Finlayson et al., published Dec. 20, 2001, describes a mobile commerce system, comprising: at least one server computer connected to receive data from and send data to a mobile phone via a mobile phone network; and at least one database storing product details; the system being arranged to receive product-identifying data from the phone, to access the database, and to return data to the phone. The terminal is a mobile commerce terminal comprising: a mobile telephone; and a barcode scanner coupled to a data input thereof. A newspaper has adverts each having a product code represented as a barcode.

U.S. Pat. No. 6,345,764, to Knowles, granted Feb. 12, 2002, describes a portable hand-held Internet access terminal. The terminal includes a bar code symbol reader in a hand-supportable housing for reading bar code symbols encoded with information, such as URLs, for use in accessing HTML-encoded documents. A telecommunication modem is operably connected to the computing platform in order to establish a two-way telecommunication link between the GUI-based browser and an Internet service provider (ISP) connected to the Internet. In response to reading a URL-encoded bar code symbol, the browser program automatically accesses a corresponding HTML-encoded document on the Internet, for display on a visual display panel integrated with the hand-supportable housing.

JP2001154965 describes the use of a barcode reader to scan URL's into a computer.

WO0209362, to Phillips, published Jan. 31, 2002, describes a wireless connection to be formed between a mobile communication device, such as a PDA, and, an output device, such as a printer, wherein the user of the PDA causes it to read a barcode from the printer so that the PDA can identify the printer in a list of discovered neighboring devices and, consequently, send appropriate connection set up signals to the printer, rather than inadvertently to some other device.

### SUMMARY OF THE INVENTION

A method of making purchases with a mobile communications device account from a vending machine includes providing a mobile communication device with an image capture mechanism; providing a vending machine with a data display; capturing the data display of the vending machine with the image capturing mechanism; decoding the data display in the mobile communication device to determine a URL for a vendor server and an identification number for the vending machine; transmitting the identification number to the vendor server; authorizing the dispensing of product from the vending machine by the vendor server; and billing the mobile communication device user account on a mobile communication device accounting server.

It is an object of the invention to provide an optical link between an vending machine and a mobile communication device.

Another object of the invention is to provide a vending machine with a variable unique ID to prevent fraudulent transactions.

A further object of the invention is to link a vending machine, mobile communication device and mobile communication device billing system over the Internet to allow purchases from a vending machine to appear on a communications statement.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the invention.

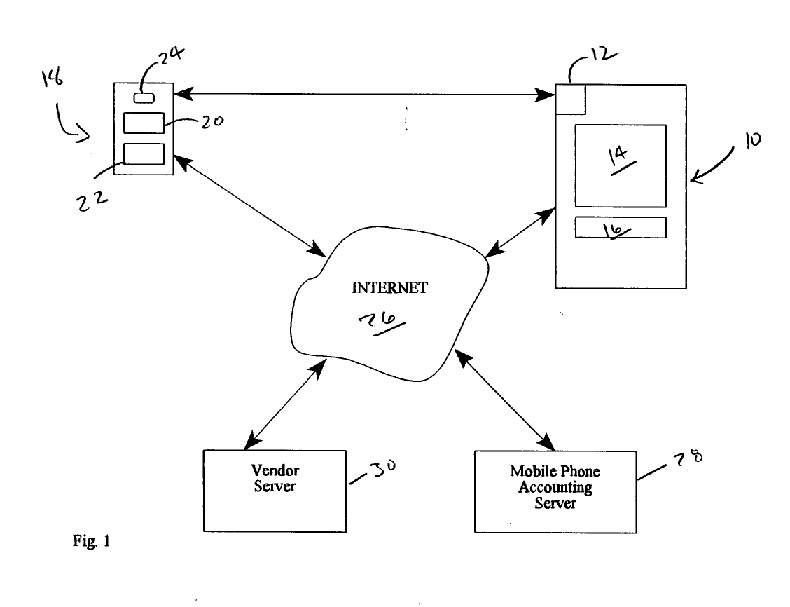

### DETAILED DESCRIPTION OF THE PREFERRED EMBODIMENTS

This invention provides a mechanism for establishing a connection between a mobile phone and an Internet-connected vending machine, and then associating that mobile phone with a specific vending machine.

The invention resolves two problems:

1. It relieves a user from launching a browser in a mobile communications device and then keying in the desired URL, thus avoiding a tedious and error prone process, and

2. It establishes the association between a mobile communications device and a vending machine having a unique ID number. This is highly desirable when using electronic payment methods to acquire merchandise from Internet connected vending machines.

Business models based on a mobile communication device-vending machine interface exist, as described in the background of the invention. Mobile communication device having image capturing mechanisms therein provide an opportunity to facilitate such transactions in a secure manner.

A vending machine 10 has a graphic display mechanism 12 which displays a unique ID number associated with vending machine 10, and which also displays a URL for an associated server. Vending machine product is shown in a product window 14, and is dispensed through a vending tray 16. It will be appreciated that vending machine 10 also accepts conventional coinage and currency. As used herein, “vending machine” includes any instrumentality which accepts an item of value in exchange for a commodity or service, thus, “vending machine” includes conventional dispensers of food and safety products, automated teller machine, point-of-sale terminals, etc.

A mobile communication device 18, e.g., a mobile phone, PDA, WiFi-equipped computer, etc., includes a display 20, a keypad 22 and an image capturing mechanism, such as a CCD camera, 24. For simplicity sake, the remainder of this disclosure will consider device 18 to be a mobile phone and image capture device 24 to be a CCD camera incorporated into the mobile phone.

Vending machine 10 and phone 18 connect to a communications network known as the Internet 26. Also connected to Internet 26 is a mobile phone accounting server 28 and a vendor server 30. The data shown in display 12 is under the control of vendor server 30, which can change the data shown in display 12 as often as necessary according to a predetermined schedule, including after every transaction if desired. Camera 24 captures the data presented on display 12, which may be in the form of a barcode, or other data-containing graphic, and, decodes the data, which defines the URL of server 30 controlling vending machine 10. Mobile phone 18 uses that data to establish a connection with vendor server 30 over Internet 26. Embedded in the graphic of display 12 is the unique ID number representing vending machine 10. This unique ID number is sent to vendor server 30 over the Internet connection, along with identification data unique to phone 18. The unique ID number verifies the mobile phone's presence at a specific vending machine. Once this link is established, server 30 authorizes vending machine 10 to vend a selection made by the user of phone 18. A charge is sent to the user's account on mobile phone account server 28 after the vending is complete. A representation of the commodity to be purchased may be represented on phone 18 display 20.

Another embodiment uses two separate graphics presented on display 12. The first contains only the URL of the vending machine's server, which is read by camera 24. A link is established to vendor server 30, which then instructs display 12 to display the a unique ID number value used to establish the association between the vending machine and the mobile phone. This embodiment provides for additional security to prevent fraudulent purchases.

Vendor server 30 has the ability to change the unique ID number on any vending machine which is connected to it over Internet 26, again, providing additional security. The use of a variable display 12 is desirable for security purposes, as the used of a fixed display, particularly the use of a printed data block, such as a barcode sticker, may lead to fraudulent use of the system. For instance, a barcode sticker could be moved from the proper vending machine to a second vending machine in a different location. When a user approaches the second vending machine and receives authorization, the authorization is really present on the first vending machine, which may be operated by a person to obtains product from the machine, on the user's account, leaving the legitimate user with a bill but no product. However, in many instances, a conventional barcode sticker affixed to vending machine 10 may suffice.

Another embodiment of the invention uses a locating device, such as GPS or AFLT, to determine the association between a mobile phone and a specific vending machine, which may be used to determine the proximity between a phone and a vending machine, thus eliminating the immediately preceding scenario. The location of the vending machine is known to the vendor server, and the locating mechanism in the phone verifies that the phone and vending machine are in close proximity.

The invention may be used by manufacturers to identify purchases of specific classes of products, which information may be used to inform a user of other, related products of the manufacturer, which information may be sent to the browser associated with the phone, or the user's convention EMail address.

Thus, an optical link between an vending machine and a mobile phone has been disclosed, along with a billing mechanism therefore. It will be appreciated that further variations and modifications thereof may be made within the scope of the invention as defined in the appended claims.

1. A method of making purchases with a mobile communications device account from a vending machine comprising:
providing a mobile communication device with an image capture mechanism;
providing a vending machine with a data display;
capturing the data display of the vending machine with the image capturing mechanism;
decoding the data display in the mobile communication device to determine a URL for a vendor server and an identification number for the vending machine;
transmitting the identification number to the vendor server;
authorizing the dispensing of product from the vending machine by the vendor server; and
billing the mobile communication device user account on a mobile communication device accounting server.

2. The method of claim 1 wherein said providing a vending machine with a data display includes providing a variable data display which is changed at predetermined intervals by the vendor server.

3. The method of claim 2 wherein a first display includes data containing a vendor server URL, and wherein, upon establishment of communications between the mobile communication device and the vendor server, the vendor server transmits a signal to the vending machine causing the vending machine display to display a unique identification number, which is captured by the mobile communication device and transmitted to the vendor server before product is dispensed by the vending machine.

4. The method of claim 1 wherein the mobile communication device is equipped with a locating mechanism, wherein the location of the mobile communication device is transmitted to the vendor server, and wherein the vendor server verifies that the mobile communication device is in proximity of the vending machine before product is dispensed by the vending machine.

5. The method of claim 1 which further includes displaying a representation of a commodity to be purchased on a display of the mobile communication device.

6. A method of making purchases with a mobile communications device account from a vending machine comprising:
providing a mobile communication device with an image capture mechanism;
providing a vending machine with a variable data display;
capturing the data display of the vending machine with the image capturing mechanism;
decoding the data display in the mobile communication device to determine a URL for a vendor server and an identification number for the vending machine;
transmitting the identification number to the vendor server;
authorizing the dispensing of product from the vending machine by the vendor server; and
billing the mobile communication device user account on a mobile communication device accounting server.

7. The method of claim 6 wherein a first display includes data containing a vendor server URL, and wherein, upon establishment of communications between the mobile communication device and the vendor server, the vendor server transmits a signal to the vending machine causing the vending machine display to display a unique identification number, which is captured by the mobile communication device and transmitted to the vendor server before product is dispensed by the vending machine.

8. The method of claim 6 wherein the mobile communication device is equipped with a locating mechanism, wherein the location of the mobile communication device is transmitted to the vendor server, and wherein the vendor server verifies that the mobile communication device is in proximity of the vending machine before product is dispensed by the vending machine.

9. The method of claim 6 which includes changing the variable data display at predetermined intervals by the vendor server.

10. The method of claim 6 which further includes displaying a representation of a commodity to be purchased on a display of the mobile communication device.
